(19) United States
(12) Patent Application Publication
(10) Pub. No.: US 2003/0118039 A1
(43) Pub. Date: Jun. 26, 2003

(54) Gateway

(76) Inventors: Hidetaka Nishi, Fukuoka (JP); Koji Hikida, Fukuoka (JP); Kenji Yamada, Fukuoka (JP)

Correspondence Address: KATTEN MUCHIN ZAVIS ROSENMAN, 575 MADISON AVENUE, NEW YORK, NY, 10022-2585, US

(21) Appl. No.: 10/317,552

(22) Filed: Dec. 12, 2002

(30) Foreign Application Priority Data
Dec. 17, 2001 (JP) 2001-382541 (PAT.

(51) Int. Cl. H04L 12/28

(52) U.S. Cl. 370/401

(57) ABSTRACT

A gateway, for connecting an existing public switched telephone network (PSTN) and an Internet Protocol (IP) network, separating hardware into an interface unit with the PSTN, a processing unit having a conversion function between a PCM signal and IP packets, an IP interface unit, and a control unit for controlling the overall apparatus. By switching these hardware blocks to match with the type of the network and the type of the media, it becomes possible to achieve compatibility with various types of PSTNs and IP networks and various services such as VoIP and NAS/RAS. Also, a function block for enabling access to the duplex control units from a maintenance system or the like by a single MAC address and autonomously restoring the system from failure due to a software logic conflict and a function block for preventing file destruction are provided.

### BACKGROUND OF THE INVENTION

1. Field of the Invention

The present invention relates to a gateway for connecting an existing public switched telephone network (PSTN) and an Internet Protocol (IP) network, more particularly relates to the configuration of a gateway compatible with different types of networks and having a high reliability against software failure.

2. Description of the Related Art

A conventional gateway consists of three pieces of hardware: a line processing unit on a Synchronous Transfer Mode (STM) line side, an IP processing unit on the IP network side, and a control unit for controlling them. The IP processing unit is hardware for extracting Pulse Code Modulation (PCM) signal data from the STM line, performing processing for forming IP packets, and transferring the packets to the IP network and performing processing in reverse to that.

The processing for forming IP packets required a specific hardware processing circuit for the type of medium, i.e., a circuit differing depending on the voice, image, data, and other communication information to be processed, e.g., one terminating voice, data, etc., performing coding and decoding (CODEC) processing for voice service, and performing modulation and demodulation (MODEM) processing for data service.

Further, there are different types of interfaces for IP networks such as Ethernet® interfaces and Asynchronous Transmission Mode (ATM) interfaces. A hardware interface circuit compatible with each of these types was necessary. That is, a large number of different hardware circuits compatible with the different types of media and types of IP networks were necessary. When there were n types of media and N types of IP networks, n×N types of hardware interface circuits were necessary.

Further, when performing maintenance on a gateway, the gateway is connected with a maintenance manager system via an IP network. The maintenance manager system is a general purpose system. Therefore, when a Media Access Control (MAC) address in the gateway is changed by switching between active/standby sides in the gateway, the network connection is broken once and therefore must be reestablished. The time taken for this reconnection differs considerably depending on the cycle of updating the routing table in the routers and other network hardware, so obstructed efficient maintenance.

Further, in the past, at the time of software failure, the gateway did not autonomously switch between active/standby sides, reinitialize the failed location, and reinstall the hardware. Therefore, when a software failure occurred, a maintenance operator had to intervene to switch between the active/standby side in the case of a duplex configuration or reinstall the hardware in the case of a single configuration. This made the work of the maintenance operator troublesome. Further, in the case of a duplex configuration, the reliability was lowered due to the operation by just the standby side in the interval before the maintenance operator finished his work, while in the case of a single configuration, the time of suspension of service became longer.

Further, in an apparatus provided with a file system, there was the problem that, when accessing the apparatus and/or system from the outside (including other side in a duplex configuration), the files sometimes ended up being destroyed due to the reinitialization (reset) and the like during file access.

### SUMMARY OF THE INVENTION

An object of the present invention is to provide a gateway for converting between a PCM signal transferred at an existing PSTN and IP packets transferred at an IP network and thereby enabling interconnection of the existing PSTN and the IP network, which can easily be matched in its interface to various types of media and types of networks by a flexible hardware configuration.

Another object of the present invention is to provide a highly reliable duplex configuration gateway where, while the network connection with the maintenance manager system is broken once at the time of switching between active/standby sides, the time until reconnection is shortened.

Still another object of the present invention is to provide a gateway autonomously switching between active/standby sides, reinitializing a failed location, and reinstalling hardware without intervention of a maintenance operator, achieving a reduction of the work of the maintenance operator and a reduction of the time of operation in the single configuration state and thereby an improvement of the reliability, preventing file destruction due to hardware reset when accessing an apparatus provided with a file system at the time of restoration from the failure and restart of the apparatus and/or system, and thereby achieving an improvement of maintainability.

To attain the above objects, according to the present invention, (1) there is provided a gateway for connecting a PSTN and an IP network, comprising an interface unit with the PSTN, an interface unit with the IP network, a processing unit for media conversion between the PSTN and the IP network, and a control unit for controlling the above, all separated in different hardware blocks, where the hardware blocks of the interface units or processing unit can be individually switched to blocks compatible to the type of the PSTN or IP network to be connected or the media service to be provided.

(2) Preferably, the gateway is provided with duplex hardware blocks including the control units, identical media access control (MAC) addresses are given to the duplex hardware blocks, and any one of the duplex hardware blocks can be accessed from a maintenance system by the identical MAC addresses.

(3) Alternatively, the gateway is provided with duplex hardware blocks of the control units, a watchdog timer circuit for monitoring a software processing operation of the control unit provided in each of the duplex hardware blocks of control units, a means for notifying an occurrence of failure by a software processing unit of the failed side to the other standby side when that software processing unit can still run and by the watchdog timer circuit when that software processing unit can no longer run, and a means for, in the control unit of the standby side receiving notification of the occurrence of failure from an active side, achieving autonomously a switch sides, reinitializing the failed side, and reinstalling the dual configuration.

(4) Alternatively, the gateway is provided with a watchdog timer circuit for monitoring a software processing operation provided in the single configuration hardware block of the control unit and a means for detecting failure by a software processing unit when that software processing unit can still run at the time of a failure and by the watchdog timer circuit when that software processing unit can no longer run, notifying the occurrence of that failure to a host apparatus, and reinitializing and reinstalling the failed location under the control of the host apparatus or by a reset circuit provided in the apparatus.

(5) Alternatively, the gateway is provided with a file system, a file access indication register indicating, when a first function block has opened a file, to a second function block accessing the first function block that the file is open, and a means for restricting access to the first function block which has opened the file when said file access indication register indicates the file is open.

### BRIEF DESCRIPTION OF THE DRAWINGS

The above objects and features of the present invention will be more apparent from the following description of the preferred embodiments given with reference to the accompanying drawings, wherein:

FIG. 1 is a view of the configuration of a gateway of the present invention;

FIG. 2 is a view of the connections of processing units 20 and an IP interface unit 30;

FIG. 3 is a view of the connections of a PSTN interface unit and the processing units;

FIGS. 4A, 4B, and 4C are views of techniques for making MAC addresses appear identical in a duplex configuration;

FIG. 5 is a view of a failure restoring means at a time when the software can run in a duplex configuration system;

FIG. 6 is a view of a means for preventing file destruction;

FIG. 7 is a view of a failure restoring means at a time when the software cannot run in a duplex configuration system;

FIG. 8 is a view of a failure restoring means when the software can run in a single configuration apparatus having a host apparatus;

FIG. 9 is a view of a failure restoring means when the software cannot run in a single configuration apparatus having a host apparatus; and

FIGS. 10A and 10B are views of a failure restoring means in an independent single configuration apparatus.

### DESCRIPTION OF THE PREFERRED EMBODIMENTS

Preferred embodiments of the present invention will be described in detail below while referring to the attached figures.

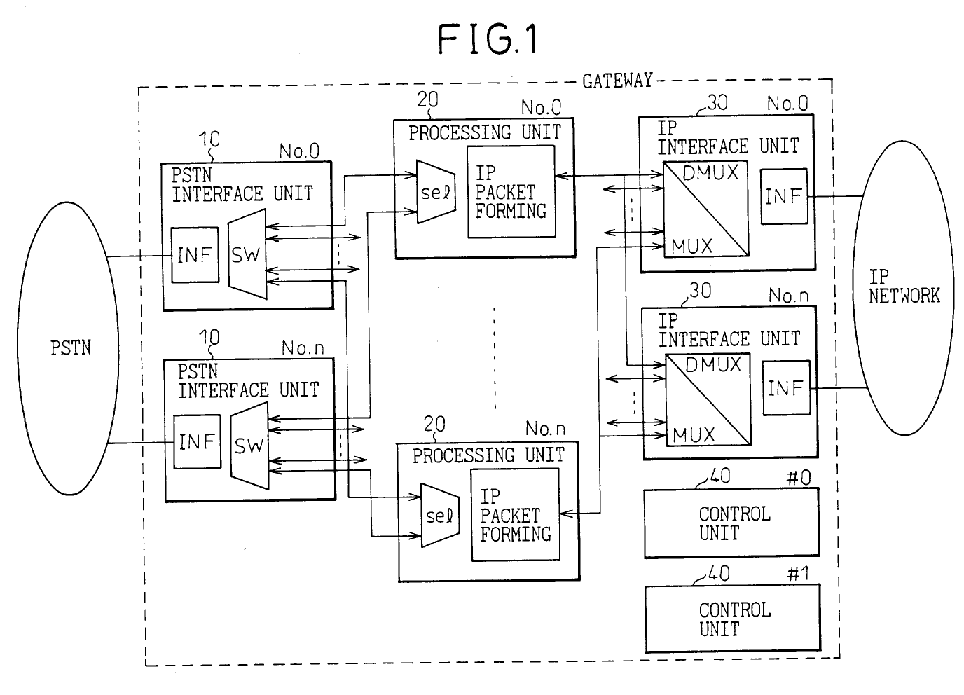

FIG. 1 shows the configuration of a gateway of the present invention. The gateway of the present invention divides the hardware into function blocks of a plurality of PSTN interface units 10 each having an interface function with a PSTN, a plurality of processing units 20 each having a conversion function between a PCM signal and IP packets, a plurality of IP interface units 30 each having an interface function with an IP network, and duplex control units 40 for controlling the overall apparatus.

Each PSTN interface unit 10 has a Layer 2 (data link layer) interface function. By switching to a unit compatible with the interface of the existing PSTN, compatibility can be achieved with various types of existing PSTN interfaces of Synchronous Digital Hierarchy (SDH), T1/E1, and other transmission formats.

Each processing unit 20 has a Layer 3 (network layer) or other processing function of other layer higher than Layer 3. By switching to a unit for the type of communication service type, it becomes possible to provide a Voice Over IP (VoIP) voice service or a Network Access Server/Remote Access Server (NAS/RAS) or other access service.

Each IP interface unit 30 has a Layer 2 (data link layer) interface function. By switching to a unit compatible with the interface of the IP network, it becomes possible to achieve compatibility with interfaces of the Ethernet®, ATM networks, etc.

The duplex control units 40 control hardware cards of the PSTN interface units 10, processing units 20, and IP interface units 30 in the gateway by software and perform control corresponding to various interfaces and services.

Mount information concerning the mounting of the various hardware cards in the gateway is stored in a configuration data section of the control units 40. The software of each of the control units 40 performs control corresponding to the various types of interfaces and services by referring to the mount information.

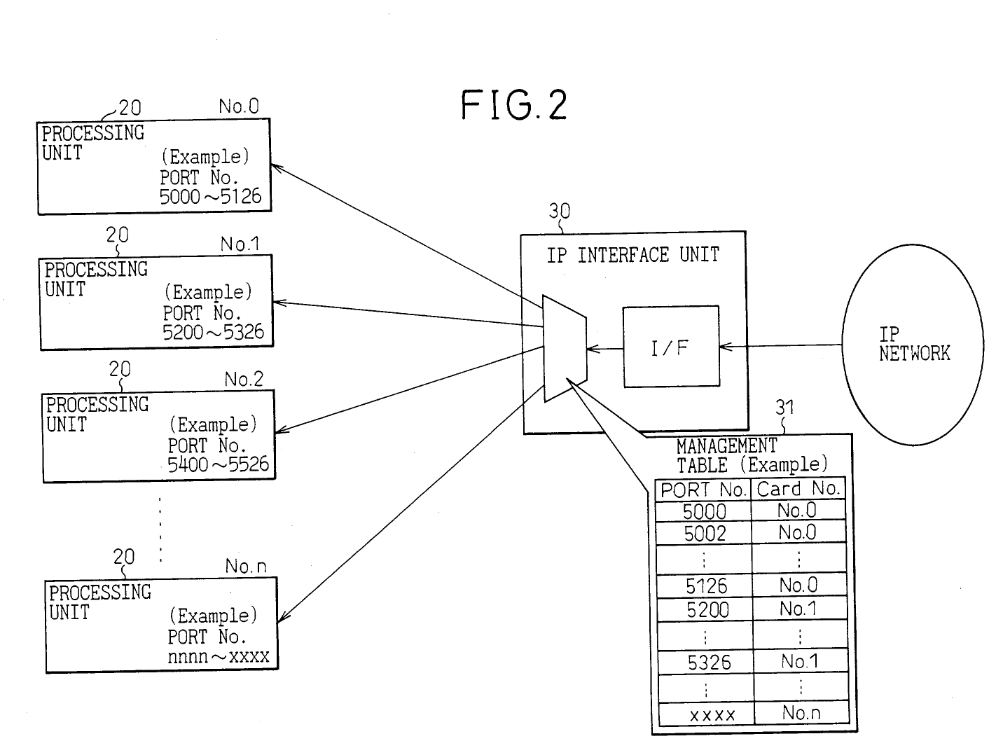

FIG. 2 shows the connections of the processing units 20 and an IP interface unit 30. In this configuration, a plurality of processing units 20 are connected to one IP interface unit 30. The IP interface unit 30 distributes received packets from the IP network to the processing units 20 using port numbers of the UDP/TCP protocol of the packets as keys.

For the interface with the IP network, port numbers of the UDP/TCP protocol are allocated to any lines in units of lines, the correspondence between port numbers and card numbers of the processing units 20 is managed by a table 31 provided in the IP interface unit 30, and the interface unit 30 transfers data packets from the IP network to the processing unit 20 serving the line for which a port number was set.

The management table 31 is set by the control units 40 and assigns ports exactly matched with the number of lines served by the processing units 20 and the capacity of the IP interface unit 30. If the UDP/TCP port number of a received packet is not found in the management table 31 at this time, it is regarded as a misaddressed packet and is discarded or otherwise processed at the IP interface unit 30. Also, control for suppressing overwriting in the management table 31 is carried out by software processing.

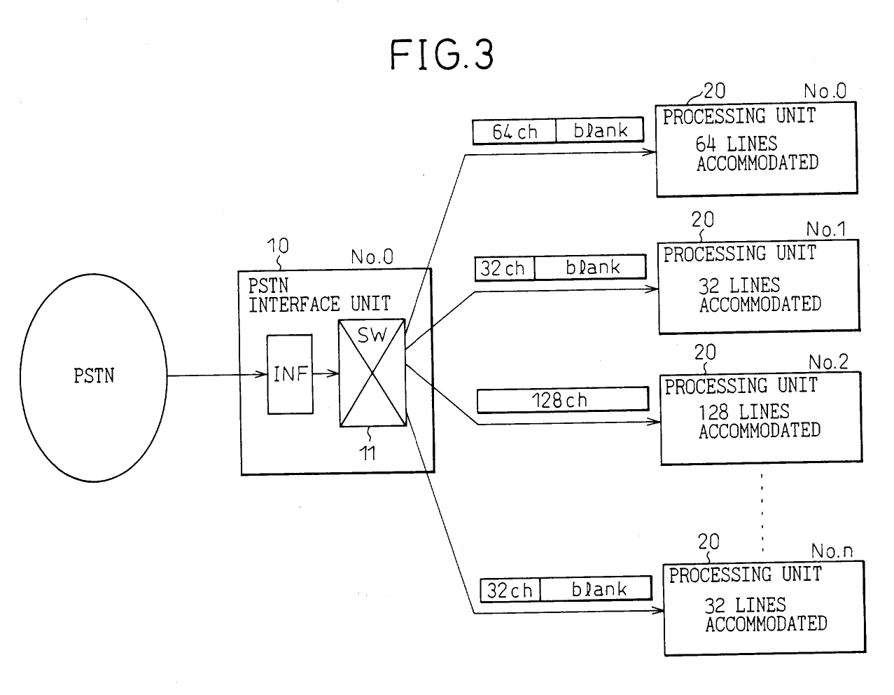

FIG. 3 shows the connections of a PSTN interface unit 10 and the processing units 20. In this configuration, a plurality of processing units 20 are connected to each PSTN interface unit 10 in the same way as the Ip interface unit 30. For this reason, a switching means 11 is provided in each PSTN interface unit 10. This switching means 11 switches a PCM signal in units of time slots depending on type of the processing units 20 (number of lines serviced).

The switching operation of the switch unit 11 can be freely set by the control units 40 of FIG. 1. The control units 40 assign the time slots exactly matched with the line type of the PSTN interface unit 10 and the number of lines serviced by the processing units 20.

Also, each processing unit 20 fetches PCM data from two-way PSTN interface units 10 of FIG. 1 and selects the fetched data under the control of the control units 40. By the combination of the control of the switching units 11 in the PSTN interface units 10 and the data fetching control in the processing units 20, the PSTN interface units 10 can be used for both duplex and decentralized configurations.

By dividing the hardware into existing PSTN interface units, processing units having Layer 3 and higher communication processing functions, and interface units with IP networks in a gateway for media conversion in connection between an existing PSTN and IP network, it is possible to connect with the Ethernet®, an ATM network, and various other networks by just switching among hardware having interface/processing functions corresponding to the various types of networks and various types of media and possible to handle a variety of services relating to Internet protocol such as VoIP and NAS/RAS.

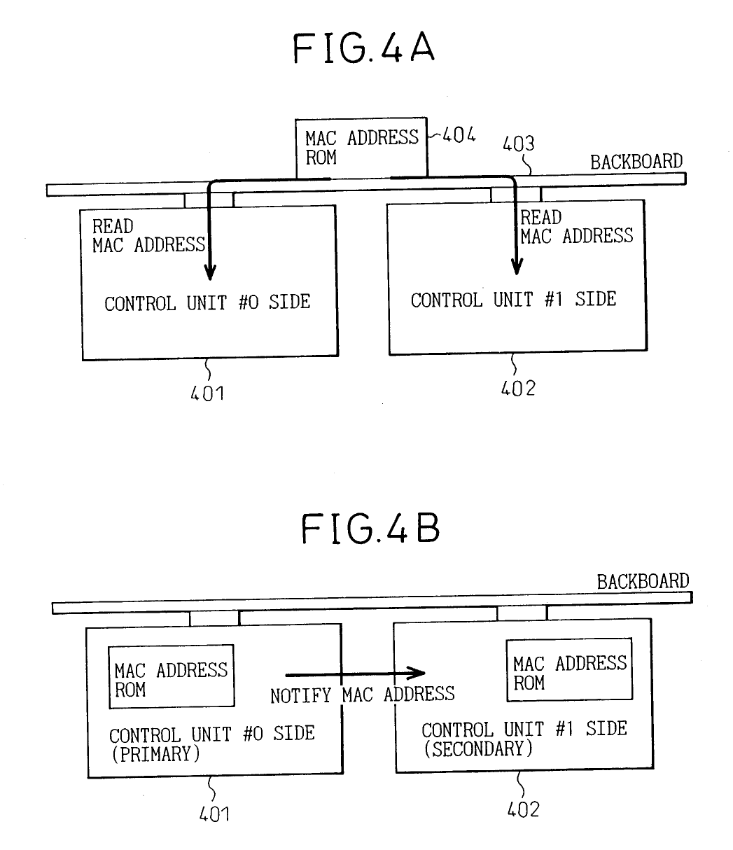

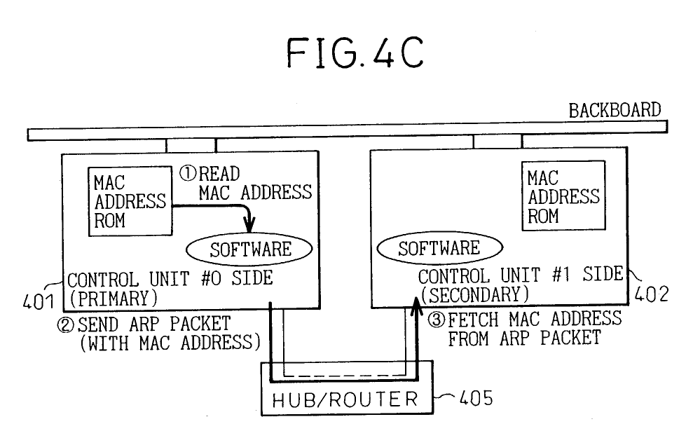

Next, an explanation will be given of the technique for making MAC addresses appear identical in a duplex configuration. FIG. 4A shows a first embodiment thereof. The MAC addresses are made to appear identical by providing a read only memory (ROM) 404 storing identical MAC addresses for the two sides on an interface that is, a backboard 403, for mounting hardware cards 401 and 402 of the control units or the like in the gateway, and reading the MAC addresses stored in the ROM 404 by using the cards 401 and 402 of the duplex sides. By this, MAC addresses are recognized as identical MAC addresses when seen from the maintenance system etc. even if the sides are switched in the gateway.

Next, an explanation will be given of a second embodiment with reference to FIG. 4B. Either of the duplex cards is defined as a primary card. Its MAC address is read from a ROM 404 mounted on that card and storing the address at the time of restart of the software for controlling that primary card. The read address is notified to the secondary card by inter-side communication for communication between the duplex control cards. Thereafter, that MAC address is used as the MAC address of the device.

Next, an explanation will be given of a third embodiment with reference to FIG. 4C. When only the gateway is connected to one hub/router 405, the side first becoming the active side (ACT) transmits an Address Resolution Protocol Packet (ARP) by broadcast. A standby side (SBY) receiving that fetches the MAC address from the ARP and uses that fetched MAC address as the MAC address of the gateway.

In the third embodiment, when the software processing unit of the control unit (#0 side) 401 of the gateway recognizes that itself (#0) is the active side (ACT) after restart, the control unit 401 sends an ARP set with the MAC address/IP address to the hub/router 405. The control software in the control unit (#1 side) 402 of the standby side (SBY) receiving this ARP from the hub/router 405 uses the address as its own (#1) MAC address.

Due to this, even after the standby side (SBY) is switched to the active side (ACT), the MAC address is recognized as identical by the system maintaining the gateway. Accordingly, while the network connection with the maintenance manager system or the like is broken once at the time of switching between active/standby sides, it becomes possible to shorten the time for reconnection.

Next, an explanation will be given of an embodiment for restoring the system at the time of a failure due to a software logic conflict. When a software failure occurs due to a software logic conflict or the like, in the case of a duplex configuration apparatus such as a gateway, the apparatus and/or system of the failed side notifies the failure to the apparatus and/or system of the other side. In the case of a single configuration apparatus, a hardware configuration register is provided for notifying the failure to the host apparatus and/or system.

Also, a hardware configuration watchdog timer (WDT) circuit may be provided so as to detect the software failure itself. In the case of an independent single configuration apparatus, further, a hardware reset setting register is provided for autonomous reset processing at the time of occurrence of a software failure. These enable autonomous processing for restoring the system when a software failure occurs.

Also, for preventing file destruction due to hardware reset at the time of automatic restoration and the time of restart, a hardware file access register indicating to the outside that a file is being access is provided. During file access, this file access register is set on, while when access is terminated, it is set off. On the other hand, the external apparatus and/or system decides whether it is possible to access the apparatus provided with the related file by referring to the setting in the file access register. By this, it becomes possible to prevent file destruction.

I. Case where apparatus is independent duplex configuration system as first aspect

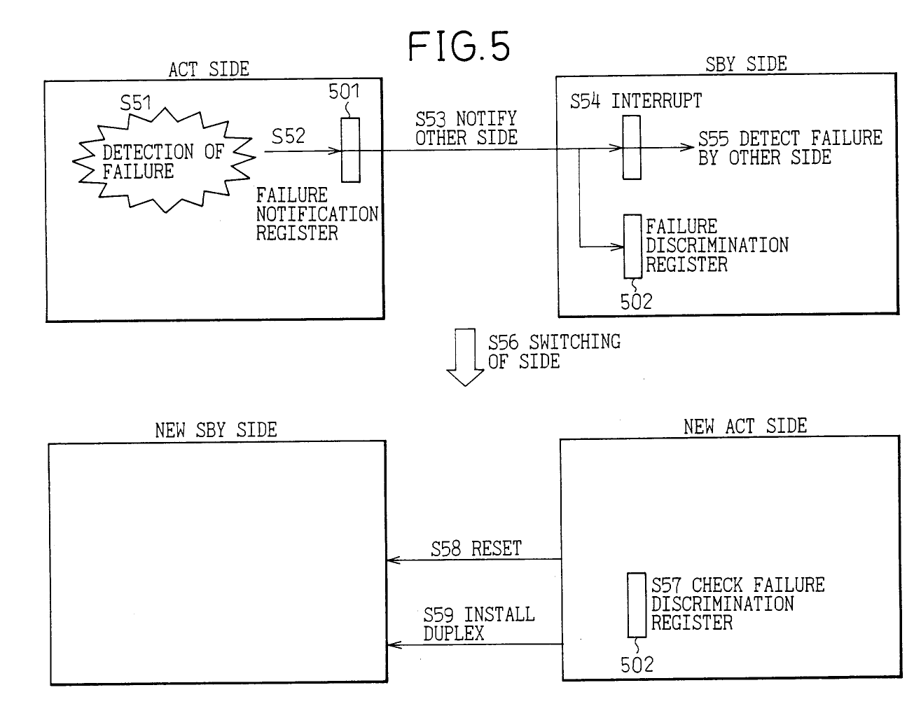

(I-1) Case where software processing unit at failed side can still run under first failure situation (refer to FIG. 5)

In this case, when a software failure occurs at the active side (ACT) of a duplex configuration apparatus and is detected (step S51), software processing is used to set on the software failure indication bit in a failure notification register 501 provided as a hardware (step S52). When this bit is set on, the hardware logic circuit notifies this to the other side (step S53), and the software failure indication bit in the failure discrimination register 502 is set on.

The standby side (SBY) receiving that failure notification is interrupted by the software processing (step S54) and detects the occurrence of failure of the other side (step S55). When the standby side (SBY) detects the occurrence of failure at the active side (ACT), first it performs processing to switch between the active side (ACT) and standby side (SBY) so that the standby side (SBY) newly becomes the active side (ACT) (step S56).

Further, the new active side (ACT) checks the software failure indication bit in the failure discrimination register 502 (step S57). When the software failure indication bit is on, it resets and reinitializes the previous active side (ACT) at which the failure occurred (step S58). After completion of the reinitialization, it autonomously reinstalls the new standby side (SBY) in the duplex configuration (step S59). In this way, it automatically reinstalls the failed side.

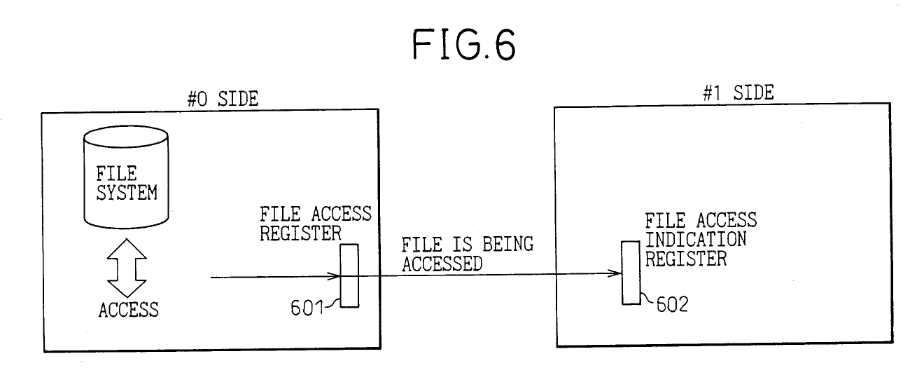

Further, when the new active side (ACT) resets the previous active side (ACT) at the above step S58, file destruction is prevented by using the following technique. As shown in FIG. 6, when accessing the file system by software processing, a file access register 601 prepared as hardware is set on. When the file access register 601 is set on, the hardware logic circuit sets a file access indication register 602 of the other side on.

Further, when the access to the file system is terminated, the file access register 601 is set off. Where it is necessary to reset the other side, the file access indication register 602 is referred to and the other side is reset after confirming that the other side is not accessing the file system. When the other side is accessing the file system, it is waited until the file access indication register 602 becomes off and the reset is carried out at the off state.

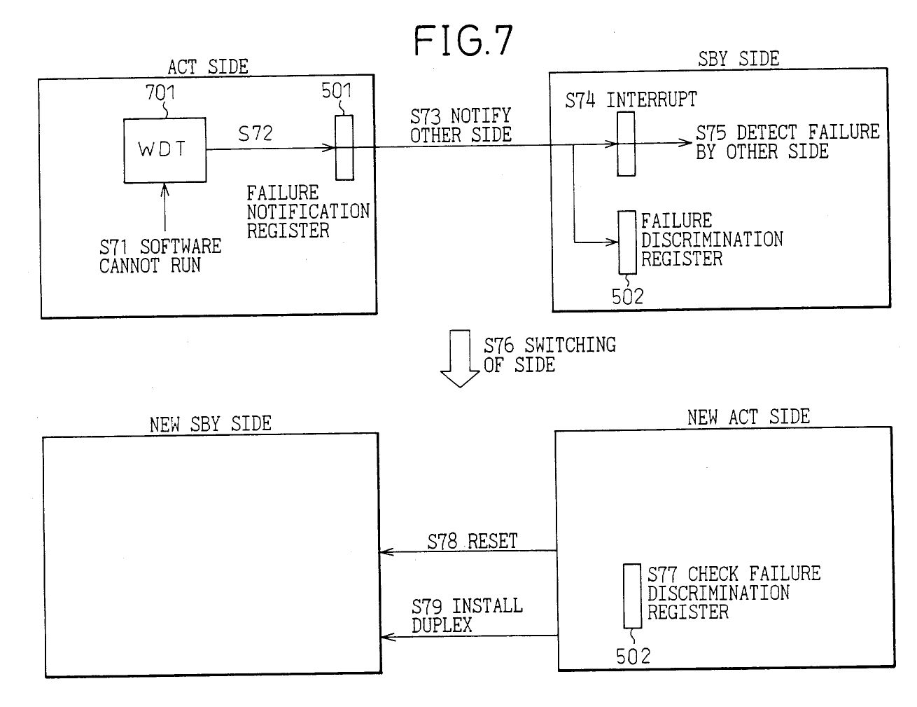

(I-2) Case where software processing unit can no longer run at failed side under second failure situation (refer to FIG. 7)

When the software processing unit no longer runs at the active side (ACT) of the duplex configuration apparatus, a watchdog timer (WDT) circuit 701 provided as the hardware circuit detects that the software cannot run (step S71).

The watchdog timer (WDT) circuit 701 is a circuit which is counted up by a clock having a constant period and is cleared at predetermined intervals by the running of the software. It detects a state where the software is inoperable if the count exceeds a predetermined value. When the count of the watchdog timer (WDT) circuit 701 exceeds the predetermined value, the software failure indication bit in the failure notification register 501 of the hardware circuit is set on (step S72).

When the bit of the failure notification register 501 is set on, the hardware logic circuit notifies the on state to the other side (step S73), and the software failure indication bit in the failure discrimination register 502 of the other side is set on. The standby side (SBY) receiving that failure notification is interrupted by the software processing (step S74) and detects the occurrence of failure at the other side (step S75). On the other hand, when the standby side (SBY) detects occurrence of failure at the active side (ACT), first it performs processing for switching between the active side/standby side (step S76) so that the standby side (SBY) newly becomes the active side (ACT).

Further, the new active side (ACT) checks the software failure indication bit in the failure discrimination register 502 (step S77). If that software failure indication bit is on, it resets and reinstalls the previous active side (ACT) in which the failure occurred (step S78). After the completion of this initialization, it uses the previous active side as the new standby side (SBY) and autonomously reinstalls the duplex configuration (step S79). In this way, it automatically reinstalls the failed side. Also, at this time, when resetting the previous active side (ACT), similar to the case of (I-1), it performs processing for preventing file destruction.

II. Case of single configuration apparatus having host apparatus as second aspect

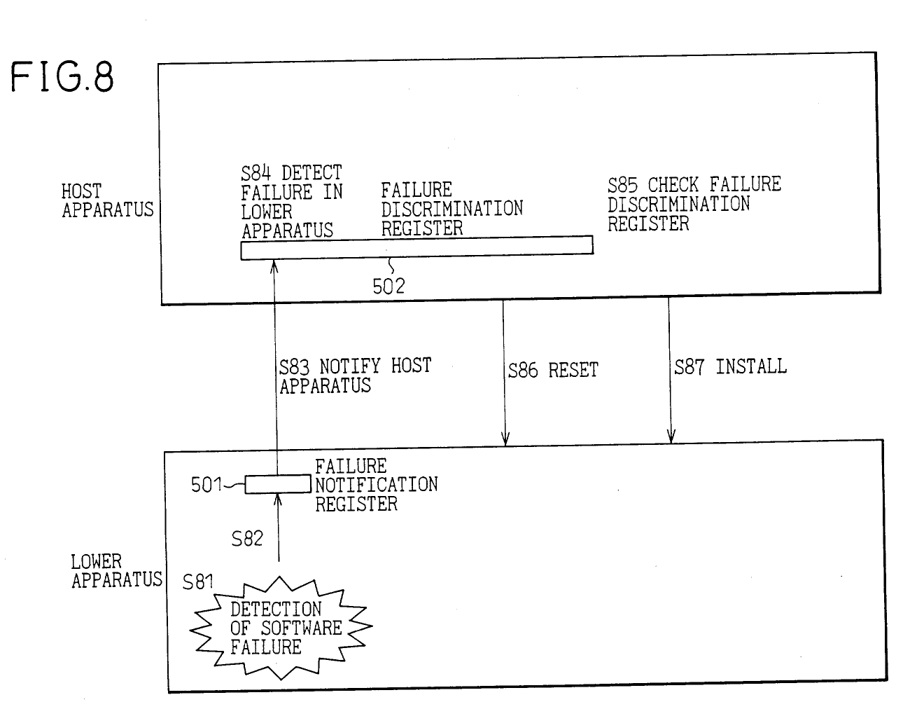

(II-1) Case where software processing unit can run in failed apparatus under first failure situation (refer to FIG. 8)

In this case, when software failure occurs in a single configuration apparatus having a host apparatus and is detected at the lower apparatus (step S81), the lower apparatus sets the software failure indication bit in the hardware configuration failure notification register 501 on by software processing (step S82). By this bit turning on, the hardware logic circuit notifies the occurrence of failure to the host apparatus (step S83), and the software failure indication bit in the failure discrimination register 502 of the host apparatus is set on.

When the host apparatus detects failure of the lower apparatus (step S84), it checks the software failure indication bit in the failure discrimination register 502 (step S85). If that software failure indication bit has been set on, it resets and reinitializes the lower apparatus in which the failure occurred (step S86), then automatically reinstalls the failed apparatus (step S87). In this case, when resetting the lower apparatus, in the same way as the case of above (I-1), it performs processing to prevent file destruction.

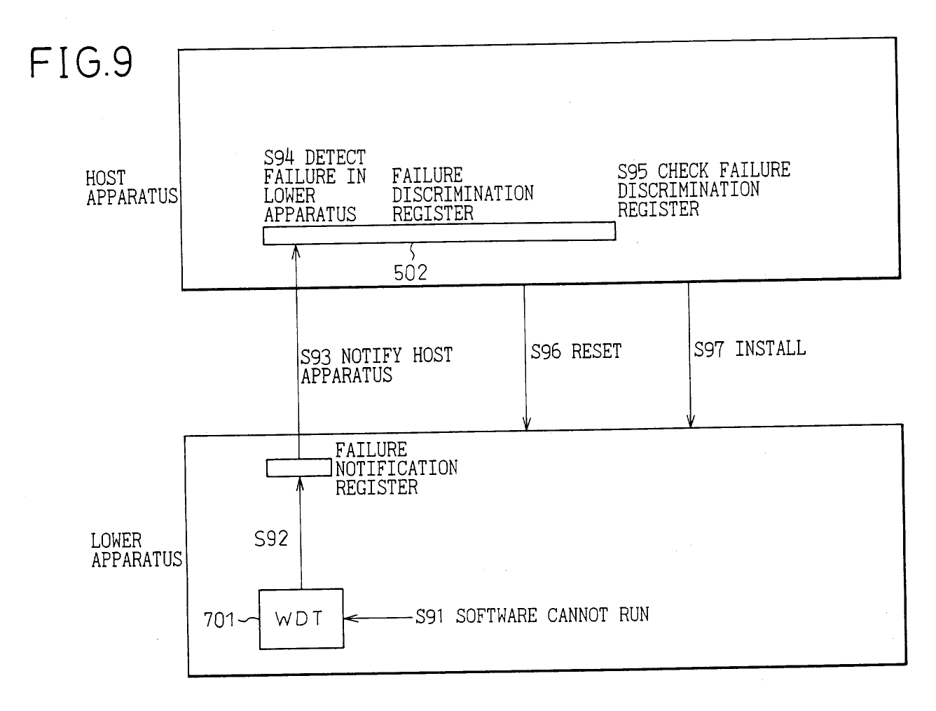

(II-2) Case where software processing unit can no longer run under second failure situation (refer to FIG. 9).

In this case, in a single configuration apparatus having a host apparatus, when software failure occurs and running becomes impossible (step S91), the watchdog timer (WDT) circuit provided as a hardware circuit detects that the software cannot run (step S92). At this time, the watchdog timer (WDT) circuit 701 sets the software failure indication bit in the failure notification register 502 prepared as a hardware circuit on.

When this bit is set on, the hardware logic circuit notifies the occurrence of failure to the host apparatus (step S93), and the software failure indication bit in the failure discrimination register 502 at the host apparatus is set on. When this host apparatus detects the failure of the lower apparatus (step S94), it checks the software failure indication bit in the failure discrimination register 502 (step S95). If that software failure indication bit is on, it resets and reinitializes the lower apparatus in which the failure occurred (step S96). In this way, it automatically reinstalls the apparatus in which the failure occurred (step S97). Also at this time, when resetting the lower apparatus, in the same way as the above (I-1), it performs processing to prevent file destruction.

III. Case of independent single configuration apparatus as third aspect

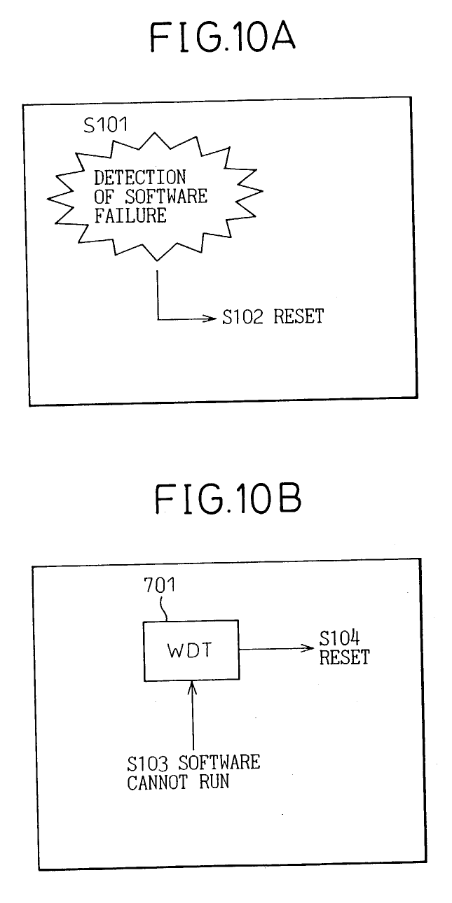

(III-1) Case where software processing unit can still run after occurrence of failure under first failure situation (refer to FIG. 10A)

In this case, when software-failure occurs in an independent single configuration apparatus and that failure is detected (step S101), the software processing unit autonomously resets, reinitializes, and reinstalls the hardware apparatus (step S102).

(III-2) Case where software processing unit can no longer run after occurrence of failure under second failure situation (refer to FIG. 10B)

In this case, when the software processing unit can no longer run in an independent single configuration apparatus (step S103), the watchdog timer (WDT) circuit 701 provided as a hardware circuit detects that the software can no longer run. When detecting the software can no longer run, the watchdog timer (WDT) circuit 701 autonomously resets, reinitializes, and reinstalls the apparatus by a hardware logic circuit (step S104).

Summarizing the effects of the invention, as explained above, according to the present invention, there is provided a gateway for media conversion in connection between an existing PSTN and an IP network which divides the hardware configuration to an interface unit with the existing PSTN, a processing unit having a Layer 3 or higher communication processing function, and an interface unit with the IP network and thereby achieves compatibility with various types of networks and types of media services by just switching to hardware having the interface/processing functions corresponding to the types of networks and media and thereby can quickly handle new interfaces and services.

Also, by giving identical MAC addresses to duplex hardware blocks and making them appear to be one MAC address when seen from a maintenance manager system, the maintenance manager system or other apparatus coupled with the gateway via the network can access the blocks without having to devise any measure to deal with the duplex configuration. As a result, at the time of switching between active/standby sides, although the network connection with the maintenance manager system is broken once, it becomes able to shorten the time for reconnection.

Further, at the time of occurrence of software failure, by providing a watchdog timer for detecting the software failure and providing a means for automatically reinitializing and reinstalling the apparatus and/or system without the intervention of a maintenance operator, the work of the maintenance operator is reduced and the time of running in the state of a single configuration is reduced, so an improvement of reliability can be achieved.

Further, by providing a means for restricting access of another function block to a function block which has opened a file, file destruction is prevented. Due to this, an improvement of the reliability and maintainability of the apparatus can be achieved.

While the invention has been described with reference to specific embodiments chosen for purpose of illustration, it should be apparent that numerous modifications could be made thereto by those skilled in the art without departing from the basic concept and scope of the invention.

The present disclosure relates to subject matter contained in Japanese Patent Application No. 2001-382541, filed on Dec. 17, 2001, the disclosure of which is expressly incorporated herein by reference in its entirety.

What is claimed is:

1. A gateway for connecting a public switched telephone network (PSTN) and an Internet Protocol (IP) network, comprising:
an interface unit with the PSTN,
an interface unit with the IP network,
a processing unit for media conversion between the PSTN and the IP network, and
a control unit for controlling the above,
all separated in different hardware blocks, where
the hardware blocks of the interface units or processing unit can be individually switched to blocks compatible to the type of the PSTN or IP network to be connected or the media service to be provided.

2. A gateway as set forth in claim 1, where duplex hardware blocks including said control units are provided, identical media access control (MAC) addresses are given to the duplex hardware blocks, and any one of the duplex hardware blocks can be accessed from a maintenance system by the identical MAC addresses.

3. A gateway as set forth in claim 1, provided with:
duplex hardware blocks of said control units,
a watchdog timer circuit for monitoring a software processing operation of a control unit provided in each of the duplex hardware blocks of the control units,
a means for notifying an occurrence of failure by a software processing unit of the failed side to the other side when that software processing unit can still run and by the watchdog timer circuit when that software processing unit can no longer run, and
a means for, in the control unit of the standby side receiving notification of the occurrence of failure from an active side, achieving autonomously a switch between sides, reinitializing the failed location, and reinstalling the duplex configuration.

4. A gateway as set forth in claim 2, provided with:
duplex hardware blocks of said control units,
a watchdog timer circuit for monitoring a software processing operation of the control unit provided in each of the duplex hardware blocks of control units,
a means for notifying an occurrence of failure by a software processing unit of the failed side to the other side when that software processing unit can still run and by the watchdog timer circuit when that software processing unit can no longer run, and
a means for, in the control unit of the standby side receiving notification of the occurrence of failure from an active side, achieving autonomously a switch between sides, reinitializing the failed location, and reinstalling the duplex configuration.

5. A gateway as set forth in claim 1, provided with:
a watchdog timer circuit for monitoring a software processing operation provided in said hardware block of the control unit, where the hardware block being a single configuration, and
a means for detecting failure by a software processing unit when that software processing unit can still run at the time of a failure and by the watchdog timer circuit when that software processing unit can no longer run, notifying the occurrence of that failure to a host apparatus, and reinitializing the failed location and reinstalling the hardware under the control of the host apparatus or by a reset circuit provided in the apparatus.

6. A gateway as set forth in claim 1, provided with:
a file system,
a file access indication register indicating, when a first function block has opened a file, to a second function block accessing the first function block that the file is open, and
a means for restricting access to the first function block which has opened the file when said file access indication register indicates the file is open.

7. A gateway as set forth in claim 2, provided with:
a file system,
a file access indication register indicating, when a first function block has opened a file, to a second function block accessing the first function block that the file is open, and
a means for restricting access to the first function block which has opened the file when said file access indication register indicates the file is open.

8. A gateway as set forth in claim 3, provided with:
a file system,
a file access indication register indicating, when a first function block has opened a file, to a second function block accessing the first function block that the file is open, and
a means for restricting access to the first function block which has opened the file when said file access indication register indicates the file is open.

9. A gateway as set forth in claim 4, provided with:
a file system,
a file access indication register indicating, when a first function block has opened a file, to a second function block accessing the first function block that the file is open, and
a means for restricting access to the first function block which has opened the file when said file access indication register indicates the file is open.

10. A gateway as set forth in claim 1, wherein further comprising a management table for allocating UDP/TCP port numbers of IP packets to lines of said PSTN in units of lines and managing correspondence between the UDP/TCP port numbers and card numbers of said processing unit, and said interface unit with the IP network refers to the management table and transfers IP packets from the IP network to said processing unit serving the line to which a UDP/TCP port number was allocated.

11. A gateway as set forth in claim 1, wherein a switching means is provided in said interface unit with the PSTN, and the switching means switches a PCM signal in units of time slots depending on the type of said processing unit, the type is determined by the number of lines serviced etc.

12. A gateway as set forth in claim 2, wherein further comprising a memory storing identical MAC addresses to be given to said duplex hardware blocks, the memory is mounted on a hardware, such as a backboard, accessible from the duplex hardware blocks, and the MAC addresses stored in the memory are read and set by the duplex hardware blocks.

13. A gateway as set forth in claim 2, wherein either of said duplex hardware blocks is used as a primary side, MAC addresses stored in a memory mounted in the primary side hardware block are read, and read MAC addresses are set in the secondary side hardware block.

14. A gateway as set forth in claim 2, wherein, when either of said duplex hardware blocks connected to an identical router or hub is connected to the network first via the router or hub, the MAC addresses written in the packets such as address resolution packets to be broadcast are read by said other hardware block, and the read MAC addresses are set as MAC addresses of that other hardware block.
